(19) United States
(12) Patent Application Publication
(10) Pub. No.: US 2011/0227968 A1
(43) Pub. Date: Sep. 22, 2011

(54) DISPLAY CONTROL APPARATUS AND DISPLAY APPARATUS

(75) Inventors: Masayoshi Shimizu, Kawasaki (JP); Shanshan Yu, Kawasaki (JP)

(73) Assignee: FUJISTU LIMITED, Kawasaki (JP)

(21) Appl. No.: 13/149,142

(22) Filed: May 31, 2011

Related U.S. Application Data
(63) Continuation of application No. PCT/JP2008/071824, filed on Dec. 1, 2008.

(51) Int. Cl. G09G 5/10

(52) U.S. Cl. 345/690

(57) ABSTRACT

A display apparatus includes a light control unit that changes the light transmittance or the reflectance with respect to each pixel; a plurality of light sources that irradiates light to the light control unit; a light-emission distribution calculating unit that calculates a light emission distribution when the light sources illuminate with respective set light emission intensities based on light-emission pattern data of the respective light sources that are preliminarily stored; a brightness comparing unit that compares the brightness in the light emission distribution calculated by the light-emission distribution calculating unit and the brightness of an image of a display object; and an adjustment-amount determining unit that determines an adjustment amount of the light emission intensity of each light source based on a comparison result by the brightness comparing unit.

### CROSS-REFERENCE TO RELATED APPLICATION

This application is a continuation of International Application No. PCT/JP2008/071824, filed on Dec. 1, 2008, the entire contents of which are incorporated herein by reference.

### FIELD

The embodiments discussed herein are directed to a display control apparatus and a display apparatus.

### BACKGROUND

A liquid crystal display apparatus includes a light control unit (liquid crystal panel) that can change a light transmittance condition, and a light source (backlight) that supplies light to the back of the light control unit. The liquid crystal display apparatus turns on the light source, and controls light transmittance conditions of the light control unit in accordance with display content, thereby being capable of displaying a desired image.

When a black is included in an image to be displayed, the liquid crystal display apparatus controls the light transmittance of a corresponding part of the light control unit to the minimum; however, the light control unit cannot completely shut light supplied from the light source. For this reason, the liquid crystal display apparatus has a problem that it cannot sufficiently decrease the brightness of the black, so that a displayed contrast is decreased.

To solve the problem, Japanese Laid-open Patent Publication No. 2005-258403 discloses a technology of dynamically controlling the intensity of light emitted by a light source in accordance with an image to be displayed. According to the technology, when an image to be displayed includes black, the brightness of the black is decreased by decreasing the brightness of light supplied onto a corresponding part, and accordingly decreasing the amount of light transmitting through the light control unit.

However, the technology disclosed in the Japanese Laid-open Patent Publication No. 2005-258403 has a problem of a high cost required for implementation, because a number of light emitting diodes (LEDs) are arranged on the back of the light control unit in grid, and each of the LEDs is controlled in accordance with an image to be displayed. The reason for this is because a large number of LEDs are required so that the cost of parts is high, and moreover, the cost of assembling is also high because the assembling precision needs to be high to prevent brightness irregularities from appearing on boundaries of LEDs.

### SUMMARY

According to an aspect of an embodiment of the invention, a display control apparatus controls a light control unit that changes one of light transmittance and reflectance with respect to each pixel, and a plurality of light sources that emit light to the light control unit. The display control apparatus includes a light-emission distribution calculating unit that calculates a light emission distribution when the light sources are turned on with respective set light-emission intensities based on light-emission pattern data of the respective light sources that are preliminarily stored; a brightness comparing unit that compares a brightness in the light emission distribution calculated by the light-emission distribution calculating unit with a brightness of an image of a display object; and an adjustment-amount determining unit that determines an adjustment amount of a light emission intensity of each light source based on a comparison result by the brightness comparing unit.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a block diagram that depicts a configuration of a display apparatus according to an embodiment of the present invention;

FIG. 2A is a schematic diagram that depicts an example of the shape of a light emission pattern of a light source;

FIG. 2B is a schematic diagram that depicts an example of the shape of a light emission pattern of a light source;

FIG. 2C is a schematic diagram that depicts an example of the shape of a light emission pattern of a light source;

FIG. 3 is a schematic diagram that depicts an example of a correction pattern data;

FIG. 4 is a block diagram that depicts a configuration of a light-source intensity adjusting unit;

FIG. 5A is a schematic diagram that depicts an example of a section split;

FIG. 5B is a schematic diagram that depicts an example of a section split;

FIG. 5C is a schematic diagram that depicts an example of a section split;

FIG. 6 is a schematic diagram that depicts an example of a light emission pattern;

FIG. 7 is a schematic diagram that depicts a light emission pattern in a three-dimensional graph;

FIG. 8 is a schematic diagram that depicts a comparative example between a light emission patter and an image;

FIG. 9 is a flowchart that depicts a process procedure of light-source intensity adjustment processing;

FIG. 10 is a flowchart that depicts a process procedure of decrement adjustment processing;

FIG. 11 is a flowchart that depicts a process procedure of increment adjustment processing;

FIG. 12 is a schematic diagram that depicts an example of a section split for selecting a light source closest to a part in which the light amount is most deficient; and

FIG. 13 is a functional block diagram that depicts a computer that executes a display control program.

### DESCRIPTION OF EMBODIMENTS

Preferred embodiments of the present invention will be explained with reference to accompanying drawings. The following embodiments are explained by exemplifying a transmissive liquid crystal display apparatus; however, the technology disclosed in the present application can be applied to display apparatuses of other methods, such as a reflective liquid crystal display apparatus.

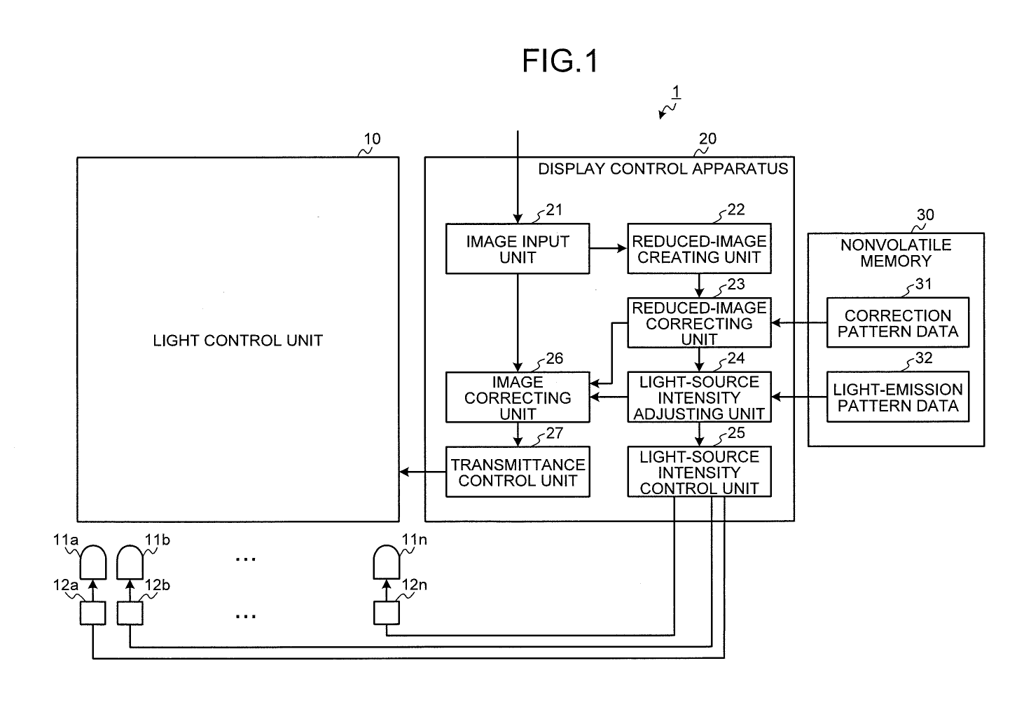

First of all, a configuration of a display apparatus 1 according to an embodiment of the present invention is explained below. FIG. 1 is a block diagram that depicts a configuration of the display apparatus 1 according to the embodiment. As depicted in FIG. 1, the display apparatus 1 includes a light control unit 10, light sources 11a to 11n, drivers 12a to 12n, a display control apparatus 20, and a nonvolatile memory 30.

The light control unit 10 can be, for example, a liquid crystal panel, and changes the light transmittance with respect to each pixel. The light sources 11a to 11n can be, for example, light emitting diodes (LEDs), and supply light from the back of the light control unit 10. In the display apparatus 1, the light sources 11a to 11n are not arranged in grid on the back of the light control unit 10, but arranged in a line along one of the sides of the light control unit 10 (a lower side in the example in FIG. 1). As the light sources 11 are arranged in a line in this way, the number of the light sources 11 can be reduced, and the cost of parts can be decreased.

An outline of a display control method according to the embodiment is explained below. The display control method according to the embodiment achieves improvement in the contrast of an image to be displayed on a display apparatus on which the light sources 11 are arranged in a line as arranged on the display apparatus 1.

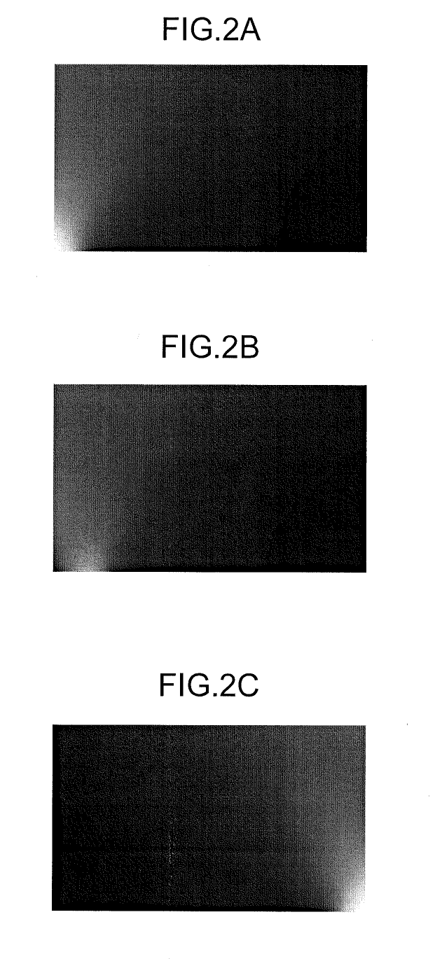

FIG. 2A is a schematic diagram that depicts a light emission pattern of the light source 11a that is arranged on the left edge of the light control unit 10; FIG. 2B is a schematic diagram that depicts a light emission pattern of the light source 11b that is arranged on the right adjacent to the light source 11a; and FIG. 2C is a schematic diagram that depicts a light emission pattern of the light source 11n that is arranged on the right edge of the light control unit 10. As depicted in the figures, each of the light emission patterns of the light sources 11 has a shape such that at the longer distance from the light source 11, the wider the spread is, and each of the light sources 11 is arranged so as to superimpose its light emission pattern on a light emission pattern of another of the light sources 11.

As the light sources 11 having a light emission pattern spreading over a wide area in such a way are arranged so as to superimpose light emission patterns, boundaries of individual light emission patterns of the light sources 11 are scarcely recognized. For this reason, by arranging the light sources 11 in a line, unnatural display of an image due to irregularities in the brightness scarcely occurs, in spite of insufficiency of assembling precision or variations in the light amounts of the light sources 11. Therefore, an arrangement of the light sources 11 in a line is advantageous also for reducing the assembling cost.

In this way, the display apparatus 1 according to the embodiment can reduce the cost of parts and the cost of assembling, and is suitable for a use with a large limitation on const, for example, a mobile phone or a monitor of on-vehicle equipment. Such devices have limitations in available electric power, therefore, decreasing the light emission intensities of the light sources 11 to improve the contrast is also favorable for power saving.

However, the display apparatus 1 cannot use the technology of Japanese Laid-open Patent Publication No. 2005-258403, which is described above, to improve the contrast of an image to be displayed. The technology disclosed in the Japanese Laid-open Patent Publication No. 2005-258403 is of associating each of LEDs arranged in grid with a rectangular section of the light control unit above the LEDs, and calculating a brightness distribution on an image to be displayed in each rectangular section, thereby controlling the light amount of a corresponding LED. In other words, the technology disclosed in the Japanese Laid-open Patent Publication No. 2005-258403 assumes that each rectangular section is supplied with light only from a corresponding LED, and does not consider that the respective light emission patterns of the light sources 11 have superimposition as superimposed according to the display apparatus 1.

Therefore, the display apparatus 1 achieves improvement in the contrast by performing control as described below. To begin with, the display apparatus 1 sets the light emission intensity of each of the light sources 11 to a predetermined value. Subsequently, the display apparatus 1 calculates a light emission distribution based on a light emission pattern of each of the light sources 11 at the light emission intensity, and compares it with an image of a display object. Based on a comparison result, if the light emission intensity of any of the light sources 11 is excessive or deficient, the display apparatus 1 then adjusts the light emission intensity of the light source 11.

The display apparatus 1 then recalculates a light emission distribution at an adjusted light emission intensity, and compares it with the image of the display object. Based on a comparison result, if the light emission intensity of any of the light sources 11 is excessive or deficient, the display apparatus 1 then adjusts the light emission intensity of the light source 11. By adjusting the light emission intensities of the light sources 11 while repeating comparisons between a light emission distribution and an image of the display object in this way, even when light emission patterns have superimposition, the light amount to be supplied to a black part on the image of the display object can be decreased, so that the contrast can be improved.

Returning to the explanation of FIG. 1, based on a control amount instructed from the display control apparatus 20, the drivers 12a to 12n drive the light sources 11a to 11n, respectively. Although according to the example depicted in FIG. 1, the light sources 11 and the drivers 12 are provided one to one, it can be configured to drive the light sources 11 with a single unit of the driver 12.

The display control apparatus 20 is a control circuit that controls the light control unit 10 and the drivers 12a to 12n; and includes an image input unit 21, a reduced-image creating unit 22, a reduced-image correcting unit 23, a light-source intensity adjusting unit 24, a light-source intensity control unit 25, an image correcting unit 26, and a transmittance control unit 27.

The image input unit 21 receives input of an image of an display object, and temporarily stores it. The reduced-image creating unit 22 creates a reduced image of the image received by the image input unit 21. For example, when the size of an input image received by the image input unit 21 is 800×400, the reduced-image creating unit 22 creates a reduced image of 200×100.

In this way, when the number of pixels is reduced to 1/16, the whole image is split into rectangles of the size of 4×4, and the maximum values of R, G, and B of pixels in a rectangle are obtained. A value combined from the maximum values of R, G, and B obtained with respect to each rectangle is to be a corresponding pixel value on the reduced image. In this way, by creating a reduced image by avoiding decreasing the brightness, it can prevent from occurring a situation that a specific pixel on an input image cannot be displayed with a sufficient brightness due to an excessive decrease in the light emission intensities of the light sources 11 in the light-emission intensity adjustment processing.

The reason for creating a reduced image is because an input image received by the image input unit 21 is too detailed to be compared with a light emission distribution of the light sources 11 so that a load of comparison processing is increased. Therefore, when the display control apparatus 20 has a sufficiently large processing capacity, or when the size of an input image is sufficiently small, it can be configured to use the input image directly without creating reduced image and to execute the subsequent processing. In addition to the method of maintaining the maximum values of R, G, and B as described above, as a method of creating a reduced image, another method that an interpolation method, such as a bilinear method, is combined can be used.

The reduced-image correcting unit 23 performs correction of a reduced image created by the reduced-image creating unit 22. Correction processing executed by the reduced-image correcting unit 23 is explained below. As depicted in FIGS. 2A to 2C, each of the light emission patterns of the light sources 11 has a shape such that at the longer distance from the light source 11, the wider the spread is. For this reason, pixels in the vicinity of the side far from the light sources 11 of the light control unit 10 are to be supplied with light from substantially all of the light sources 11.

This means that if a pixel of which the brightness of at least one of RGB is very high is present in the vicinity of the side far from the light sources 11 on the image of the display object, it is difficult to decrease the light emission intensities of the light sources 11. The reason for this is because, if the light emission intensity of one of the light sources 11 is decreased, a state is brought about such that the light amount on the side far from the light sources 11 becomes deficient in the light emission distribution, consequently no margin is left to decrease the light emission intensities of the light sources 11.

Therefore, the reduced-image correcting unit 23 performs correction for decreasing a peak of the brightness. If the peak of the brightness is decreased, a margin for decreasing the light emission intensity of some of the light sources 11 is given, so that improvement in the contrast and power saving can be achieved. However, if the peak of the brightness is excessively decreased, a displayed image becomes unnatural; therefore the amount of decrease in the peak of the brightness is appropriately set in accordance with a quality required for image display, a degree of power saving to be achieved, and the like.

Correction processing of a reduced image by the reduced-image correcting unit 23 is executed specifically as follows. To begin with, the reduced-image correcting unit 23 splits the reduced image into four in the longitudinal direction and eight in the transverse direction, i.e., 32 sections in total, and then obtains the maximum values of R, G, and B of pixels included in each section.

The reduced-image correcting unit 23 then selects a section in which the maximum value of R, G, or B is larger than a threshold (for example, 255×0.9≅230, where R, G, and B are each within the domain of 0 to 255). The reduced-image correcting unit 23 then corrects the reduced image based on correction pattern data 31 stored in the nonvolatile memory 30 in accordance with the position at which the selected section is present.

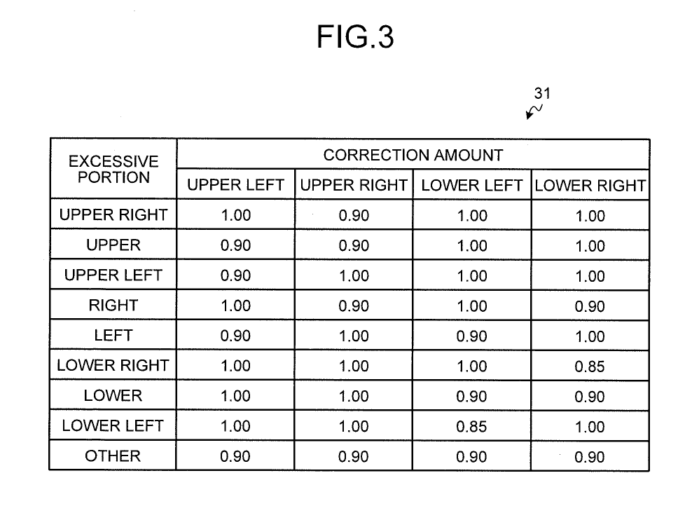

For example, when the correction pattern data 31 is set as depicted in FIG. 3, and if a selected section is only either of the two on the right hand on the uppermost row, a correction amount of the “upper right” is acquired, R, G, and B of a pixel of the upper left of the reduced image are multiplied by “1.0”, R, G, and B of a pixel of the upper right are multiplied by “0.9”, R, G, and B of a pixel of the lower left are multiplied by “1.0”, and R, G, and B of a pixel of the lower right are multiplied by “1.0”. The other pixels on the reduced image are each multiplied by a value that the correction amounts at the four corners are linearly complemented in accordance with a position. By correcting the pixels in this way, the peak of the brightness present in the upper right of the reduced image can be decreased.

If a selected section is only either of the two on the left hand on the lowermost row; a correction amount of the “lower left” is acquired, R, G, and B of a pixel of the upper left of the reduced image are multiplied by “1.0”, R, G, and B of a pixel of the upper right are multiplied by “1.0”, R, G, and B of a pixel of the lower left are multiplied by “0.85”, and R, G, and B of a pixel of the lower right are multiplied by “1.0”. The other pixels on the reduced image are each multiplied by a value that the correction amounts at the four corners are linearly complemented in accordance with a position. By correcting the pixels in this way, the peak of the brightness present in the lower left of the reduced image can be decreased.

Similarly, if a selected section is only either of the two on the left hand on the uppermost row, a correction amount of the “upper left” is acquired, and correction is performed; and if a selected section is distributed in the uppermost row, a correction amount of the “upper” is acquired, and correction is performed. If a selected section is only either of the two on the right hand on the lowermost row, a correction amount of the “lower right” is acquired, and correction is performed; and if a selected section is distributed in the lowermost row, a correction amount of the “lower” is acquired, and correction is performed. If a selected section is distributed in two right columns, a correction amount of the “right” is acquired and correction is performed; if a selected section is distributed in two left columns, a correction amount of the “left” is acquired and correction is performed; and if it is not applicable to any of the above cases, a correction amount of the “other” is acquired and correction is performed.

Here, according to the correction pattern data 31 depicted in FIG. 3, the reason why a correction amount is set small when a selected section is present in the “lower right” and when a selected section is present in the “lower left”, is because in the lower part of the image, i.e., on the side close to the light sources 11, intensity adjustment of the light sources appropriate to contents of the image can be easily performed locally and effectively.

As already explained above, light supplied to each pixel on the side far from the light sources 11 of the light control unit 10 is light composited from light emitted from a number of the light sources 11. By performing correction by the reduced-image correcting unit 23, it can avoid a situation that the light sources 11 cannot be darkened despite of a dark part because of a high pixel level of part of the image. When intending to decrease the light amount to be supplied to pixels on the side far from the light sources 11 of the light control unit 10, even if the peak of part of pixel levels of the pixels on the far side of the image is suppressed to 90%, light emitted from a number of the light sources 11 are combined, so that the pixels are darkened only to slightly higher than 90% in average.

On the other hand, light supplied to each pixel on the side close to the light sources 11 of the light control unit 10 is light composited from light emitted from one or a few of the light sources 11. Therefore, when decreasing the light amount to be supplied to pixels on the side close to the light sources 11 of the light control unit 10, if the peak of the levels of pixels are suppressed to 90%, the light sources 11 can be locally darkened to a large extent, and a large effect in average can be obtained.

The image split described in the above explanation of the correction processing by the reduced-image correcting unit 23 is an example, and a reduced image can be split in any manner. Instead of performing correction in accordance with a position at which a peak of the brightness is present as described above, it can be configured to correct a reduced image by a simple method, for example, by multiplying R, G, and B of all pixels by 0.9.

The light-source intensity adjusting unit 24 adjusts the light emission intensity of each of the light sources 11 without excess and deficiency to display a corrected reduced image based on light-emission pattern data 32 stored by the nonvolatile memory 30. A more detailed configuration and processing of the light-source intensity adjusting unit 24 will be described later.

The light-source intensity control unit 25 gives a control amount in accordance with an adjustment result by the light-source intensity adjusting unit 24 to each of the drivers 12, and controls each of the light sources 11 so as to emit light in accordance with the adjustment result by the light-source intensity adjusting unit 24.

The image correcting unit 26 corrects an input image received by the image input unit 21 so as to be appropriately displayed with a light amount supplied by each of the light sources 11 in accordance with an adjustment result by the light-source intensity adjusting unit 24. Specifically, to begin with, the image correcting unit 26 adds to the input image a correction similarly to a correction added to a reduced image by the reduced-image correcting unit 23. According to the correction processing, each pixel in the input image is corrected similarly to a corresponding pixel in the reduced image.

Subsequently, the image correcting unit 26 corrects each pixel of the input image based on a proportion with which a light amount supplied to each pixel of the light control unit 10 is changed based on the adjustment result by the light-source intensity adjusting unit 24. Specifically, a setting in the following proportionality relation is widely used in the brightness and the pixel value.

Brightness∝(pixel valuê2.2) (1)

Therefore, the image correcting unit 26 calculates a corrected pixel value by using the following Equation (2).

Corrected pixel value=pixel value before correction×(1/darkening rate)̂(1/2.2) (2)

The transmittance control unit 27 controls the transmittance of each pixel of the light control unit 10 based on each pixel of an input image corrected by the image correcting unit 26.

The nonvolatile memory 30 is, for example, a flash memory, and stores various information required for operation of the display apparatus, such as the correction pattern data 31 and the light-emission pattern data 32.

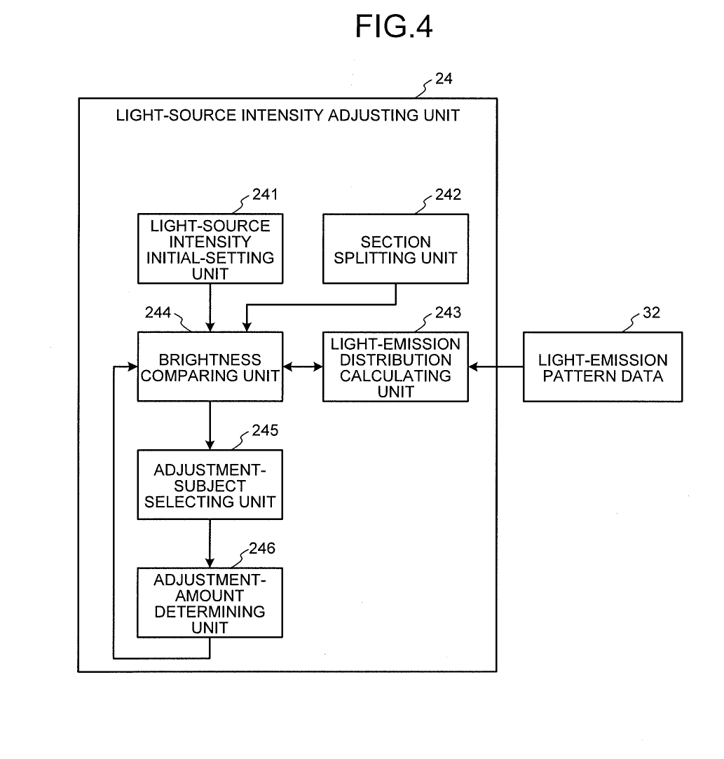

A more detailed configuration of the light-source intensity adjusting unit 24 depicted in FIG. 1 is explained below. FIG. 4 is a block diagram that depicts a configuration of the light-source intensity adjusting unit 24. As depicted in FIG. 4, the light-source intensity adjusting unit 24 includes a light-source intensity initial-setting unit 241, a section splitting unit 242, a light-emission distribution calculating unit 243, a brightness comparing unit 244, an adjustment-subject selecting unit 245, and an adjustment-amount determining unit 246.

The light-source intensity initial-setting unit 241 determines an initial value of the light emission intensity of each of the light sources 11 with respect to each input image. Specifically, the light-source intensity initial-setting unit 241 sets the light emission intensity of each of the light sources 11 that is determined with respect to the input image that is previously displayed, into the initial value of the light emission intensity of each of the light sources 11 with respect to a next input image. Because, generally, input images being input prior to and subsequent to each other are often similar, as .a previous adjustment result is set into the initial value in this way, an adjustment amount can be little, so that the adjustment can be early completed. Moreover, because the adjustment result is expected to be similar to a previous adjustment result, it can avoid causing flicker on display by the light control unit 10 due to variations in adjustments of respective input images.

When intending to decrease the light emission intensity of each of the light sources 11 as much as possible, an initial value of the light emission intensity of each of the light sources 11 can be set lower than the light emission intensity of each of the light sources 11 determined with respect to a previously-displayed input image, by a predetermined amount. By setting in this way, respective light emission intensities of the light sources 11 are set to the minimum value required for displaying a reduced image through light-emission intensity adjustment processing described later. When intending to perform processing simply, the initial value of the light emission intensity of each of the light sources 11 can be set to 90% of the maximum value across the board.

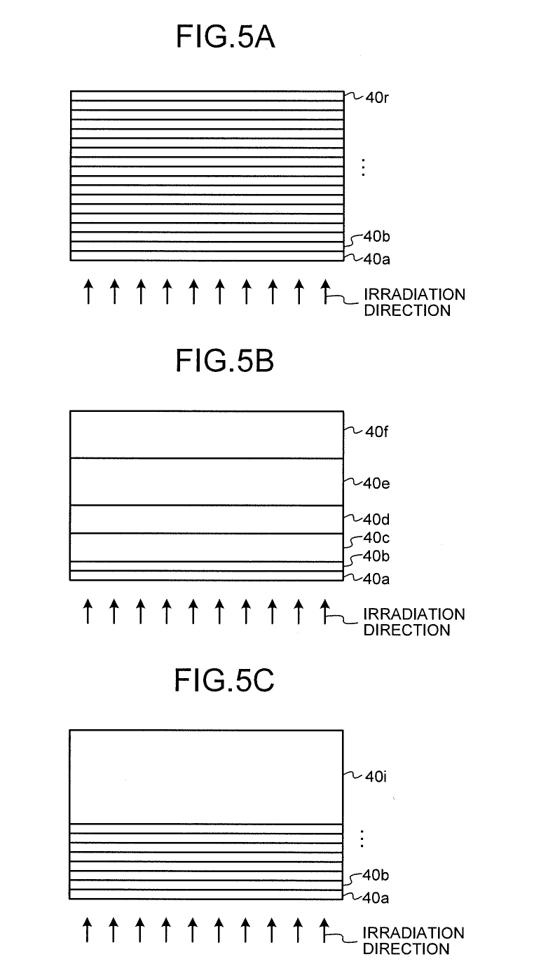

The section splitting unit 242 splits a reduced image into a plurality of sections with straight lines perpendicular to the irradiation direction. The irradiation direction here means a direction of incidence of light of the light source 11 when displaying an input image corresponding to the reduced image on the light control unit 10. An example of section split of a reduced image by the section splitting unit 242 is depicted in FIG. 5A. According to the example depicted in FIG. 5A, the reduced image is split into sections 40a to 40r in the same size.

For example, when the light sources 11 are arranged in a line on the lower part of the light control unit 10, the irradiation direction corresponds to the up-and-down direction of the image; and the lines perpendicular to the irradiation direction corresponds to the right-and-left direction of the image. In such case, the split width when splitting into a plurality of sections as depicted in FIG. 5A can be, for example, 32 to 64 lines. Although the image can be split with respect to each line, a split width including a certain number of lines can be efficient in terms of calculation.

The light-source intensity adjusting unit 24 selects a split section (the section 40a in the example in FIG. 5A) as an adjustment target in descending order of proximity to the irradiation direction from the sections that are split in this way; performs comparison of a corresponding part in the light emission distribution of the light sources 11, thereby adjusting the light emission intensity of each of the light sources 11. The reason for this is because, as explained above, a pixel at a position close to the light sources 11 receives supply of light only from one or a few of the light sources 11, few options are available of selecting which of the light sources 11 that the light emission intensity is to be adjusted, and an optimal solution or a nearly optimal solution is limited, so that a darkening amount of the light source 11 of an adjustment subject has to be priorly determined.

The light-emission distribution calculating unit 243 calculates a light emission distribution composited from distributions of light supplied by all of the light sources 11, based on the light-emission pattern data 32.

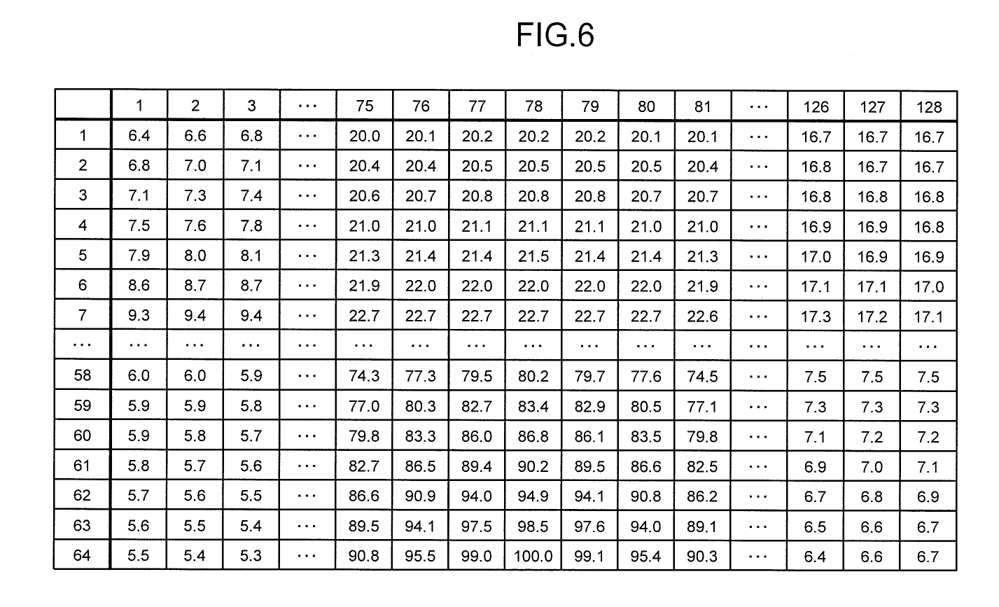

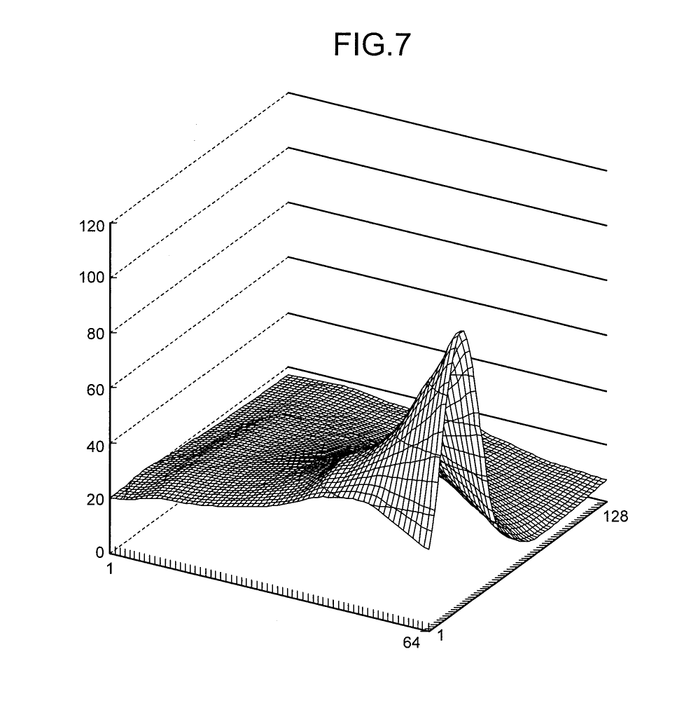

The light-emission pattern data 32 is explained below. FIG. 6 is a schematic diagram that depicts an example of a light emission pattern of one of the light sources 11 at the 10th from the right among 24 of the light sources 11 arranged in line, and the unit of each numerical value is cd/m². FIG. 7 is a schematic diagram that depicts a light emission pattern depicted in FIG. 6 in a three-dimensional graph. As depicted in the figures, the light-emission pattern data 32 includes information indicating at which position of the light control unit 10 and to what extent of the brightness the light is supplied when individually turning on each of the light sources 11 with 100% of the intensity.

The light-emission distribution calculating unit 243 multiplies the light emission pattern of each of the light sources 11 included in the light-emission pattern data 32 by the light emission intensity of each of the light sources 11, thereby obtaining the brightness at each position on the light control unit 10 when turning on each of the light sources 11 as a single unit. The light-emission distribution calculating unit 243 then sums the obtained brightnesses with respect to each position on the light control unit 10, thereby calculating a light emission distribution when turning on all of the light sources 11 with the respective light emission intensities.

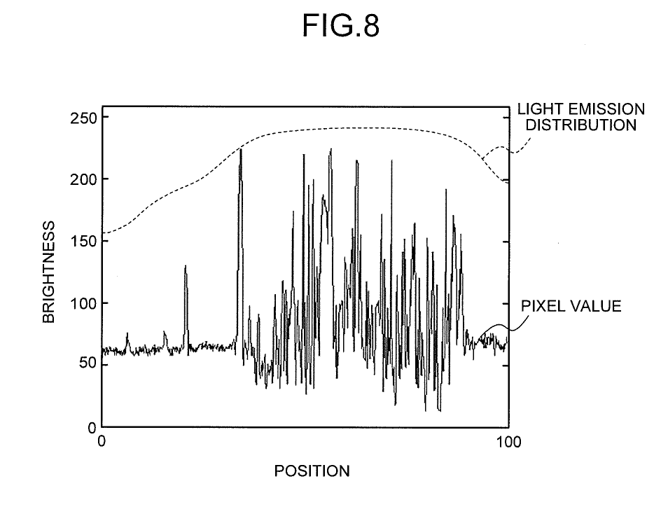

The brightness comparing unit 244 compares the brightness of a part corresponding to a section that is the adjustment target of each of the light sources 11 in a reduced image, with the brightness of a corresponding part in the light emission distribution. A comparative example of the brightness when the section 40a depicted in FIG. 5A is the adjustment target of each of the light sources 11 is depicted in FIG. 8. For the purpose of simplifying explanation, it is assumed that the resolution in the direction perpendicular to the irradiation direction of the reduced image is 100 pixels, the light emission pattern included in the light-emission pattern data 32 is such that the light control unit 10 is sectioned into 100 in a direction along which the light sources 11 are arranged.

A graph expressed by a solid line in FIG. 8 indicates pixel values of respective pixels that are obtained by scanning a part corresponding to the section 40a in the reduced image, along the direction perpendicular to the irradiation direction. A graph expressed by a broken line in FIG. 8 indicates the brightness at positions corresponding to respective pixels of the section 40a in the light emission distribution. The brightness in the light emission distribution is converted based on Expression (1) described above so as to be comparable directly with pixel value.

The brightness comparing unit 244 compares the light emission distribution and pixel values with respect to each position; and then if a part in which the brightness in the light emission distribution is less than the pixel value on the reduced image is found, the brightness comparing unit 244 causes the adjustment-subject selecting unit 245 to select the light source 11 to be an adjustment subject. The adjustment-amount determining unit 246 then determines to what extent the light emission intensity of the selected light source 11 is to be increased.

Moreover, the brightness comparing unit 244 compares the light emission distribution and the pixel values with respect to each position; and if part in which the brightness in the light emission distribution is less than the pixel value on the reduced image is not found, the brightness comparing unit 244 causes the adjustment-subject selecting unit 245 to select the light source 11 available to decrease its light emission intensity. If the light source 11 available to decrease its light emission intensity is selected, the adjustment-amount determining unit 246 determines to what extent the light emission intensity of the selected light source 11 is to be decreased.

After the light emission intensity of the selected light source 11 is adjusted by the adjustment-subject selecting unit 245, a light emission distribution that reflects an adjustment result of the light emission intensity is calculated by the light-emission distribution calculating unit 243, and the calculated light emission distribution is again compared with the reduced image. At the step, if the light source 11 of which light emission intensity is adjustable is found, the light emission intensity of the light source 11 is adjusted, and a light emission distribution is again calculated. Such processing is to be repeated until the light source 11 of which light emission intensity is adjustable is not left.

When the light source 11 of which light emission intensity is adjustable is not left, similar processing is executed on an adjacent section as the adjustment target; and finally, when the light source 11 of which light emission intensity is adjustable is not left in any of the sections, the light-source intensity adjustment processing is completed. With respect to the second and later sections, selection of the light source 11 available to decrease its light emission intensity is not performed. The reason for this is because if the light emission intensity of the light source 11 is decreased in the second or a later section, there is a possibility that the light amount for displaying a reduced image in already adjusted sections may be deficient in some cases.

When performing comparison between a light emission pattern and a reduced image in order starting from the section closest to the irradiation direction, except a case where a large brightness difference is present in the reduced image, the brightness in the light emission distribution substantially hardly fall below the brightness of the reduced image in sections distant to a certain extent from the irradiation direction. Therefore, adjustment of the light emission intensity of each of the light sources 11 is substantially not performed.

In this way, in a section distant to a certain extent from the irradiation direction, adjustment of the light emission intensity is not required in many cases. Therefore, as depicted in FIGS. 5B and 5C, the size of a section far from the irradiation direction can be larger than the size of a section close to the irradiation direction. By splitting sections in this way, the time required for the light-source intensity adjustment processing can be shortened, substantially without decreasing the precision of adjustments of the light sources 11.

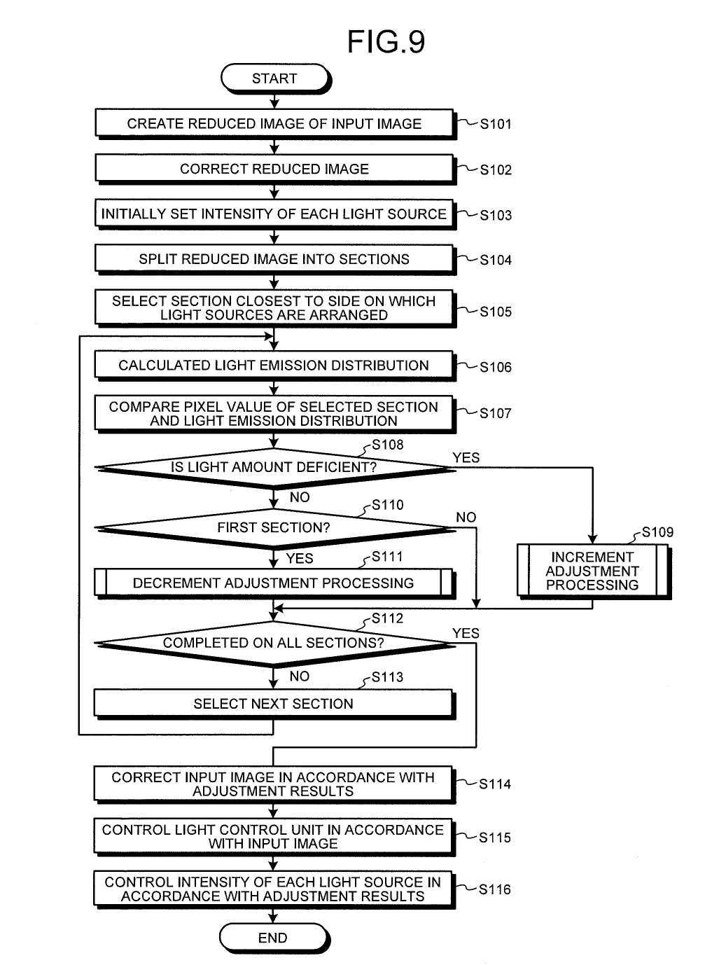

A process procedure of light-source intensity adjustment processing is explained below. FIG. 9 is a flowchart that depicts a process procedure of light-source intensity adjustment processing. The display control apparatus 20 executes the process procedure each time when a new input image is received by the image input unit 21.

As depicted in FIG. 1, to begin with, the reduced-image creating unit 22 creates a reduced image of an input image (Step S101); and the reduced-image correcting unit 23 corrects the reduced image according to the above described method (Step S102).

The light-source intensity initial-setting unit 241 then initially sets the light emission intensity of each of the light sources 11 (Step S103); and the section splitting unit 242 splits the reduced image into sections (Step S104). Subsequently, the light-source intensity adjusting unit 24 selects as an adjustment target, a section closest to the irradiation direction from among the split sections, i.e., a section that is closest, when displayed, to the side on which the light sources 11 are arranged (Step S105).

The light-emission distribution calculating unit 243 then calculates a light emission distribution (Step S106); and the brightness comparing unit 244 compares a pixel value in the selected section and the brightness of a corresponding part in the light emission distribution (Step S107). If there is a part deficient in the light amount (Yes at Step S108), increment adjustment processing described later is executed (Step S109).

By contrast, if there is no part deficient in the light amount (No at Step S108), and if the selected section is the first section (Yes at Step S110), decrement adjustment processing described later is executed (Step S111). If the selected section is the second or a later section (No at Step S110), the decrement adjustment processing is not executed.

After the processing on the section of the adjustment target is completed in this way, if the sections have not been selected all yet as the adjustment target (No at Step S112), the light-source intensity adjusting unit 24 selects the next section as the adjustment target (Step S113), and the process procedure is restarted from Step S106.

By contrast, if all of the sections have been selected as the adjustment target (Yes at Step S112), the image correcting unit 26 corrects the input image in accordance with the adjustment results (Step S114). The transmittance control unit 27 then controls the transmittance of each pixel of the light control unit 10 in accordance with the corrected input image (Step S115); and the light-source intensity control unit 25 controls the light emission intensity of each of the light sources 11 in accordance with the adjustment results (Step S116).

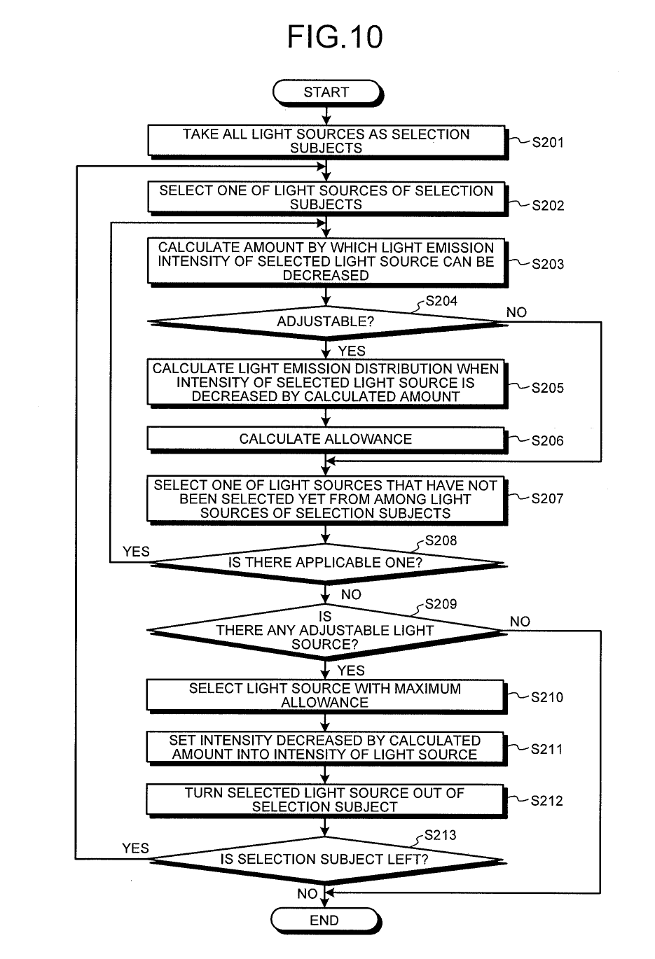

FIG. 10 is a flowchart that depicts a process procedure of the decrement adjustment processing depicted in FIG. 9. As depicted in FIG. 10, to begin with, the light-source intensity adjusting unit 24 subjects all of the light sources 11 to selection (Step S201). The light-source intensity adjusting unit 24 then selects one of the light sources 11 subjected to the selection (Step S202); the adjustment-amount determining unit 246 calculates to what extent the light emission intensity of the selected light source 11 can be decreased within a range in which light amount deficiency does not occur (Step S203).

The decrement of the light emission intensity can be limited, for example, up to 30%. The reason for this is because if the light amount is decreased to a large extent, variations in the brightness between images displayed before and after each other become large, consequently sometimes resulting in a defect, such as flicker, in some cases.

If there is a margin for decreasing the light emission intensity of the selected light source 11 (Yes at Step S204), the light-emission distribution calculating unit 243 calculates a light emission distribution of a case of decreasing the light emission intensity of the selected light source 11 by the calculated amount (Step S205). The adjustment-amount determining unit 246 then calculates as an allowance the sum of amounts by which the light emission intensities of the others of the light sources 11 can be decreased within a range in which light amount deficiency does not occur, based on the calculated light emission distribution (Step S206).

By contrast, if there is no margin for decreasing the light emission intensity of the selected light source 11 (No at Step S204), the calculation of an allowance is not performed.

Subsequently, the light-source intensity adjusting unit 24 selects one of the light sources 11 that have not been selected yet from among the light sources 11 subjected to the selection (Step S207). If one of the light sources 11 that has not been selected is selected (Yes at Step S208), the process procedure is restarted from Step S203.

By contrast, if any of the light source 11 that has not been selected yet is not selected, in other words, verification has been completed with respect to all of the light sources 11 subjected to the selection (No at Step S208), the light-source intensity adjusting unit 24 confirms whether any of the light sources 11 has a margin for decreasing its light emission intensity (Step S209). If none of the light sources 11 has margin for decreasing its light emission intensity (No at Step S209), the decrement adjustment processing is terminated.

By contrast, if any one of the light sources 11 has a margin for decreasing its light emission intensity (Yes at Step S209), the adjustment-subject selecting unit 245 selects the light source 11 with the maximum allowance as an adjustment subject (Step S210). The adjustment-amount determining unit 246 then sets a light emission intensity decreased by the calculated decrement into the light emission intensity of the light source 11 (Step S211). The light-source intensity adjusting unit 24 turns the light source 11 out of the selection subject (Step S212); if any of the light sources 11 subjected to the selection is left (Yes at Step S213), the process procedure is restarted from Step 5202; by contrast, if no selection subject is left (No at Step S213), the decrement adjustment processing is terminated.

Although according to the above process procedure, to obtain a large decrement in total, it is configured to decrease the light emission intensities of the light sources 11 in descending order of allowances; to simplify the processing, it can be configured to decrease the light emission intensities in descending order of margins for decreasing the light emission intensity. Moreover, to avoid producing irregularities in the brightness, it can be configured to adjust a difference in decrements of the light emission intensities of the adjacent light sources 11 so as to be equal to or less than a predetermined amount.

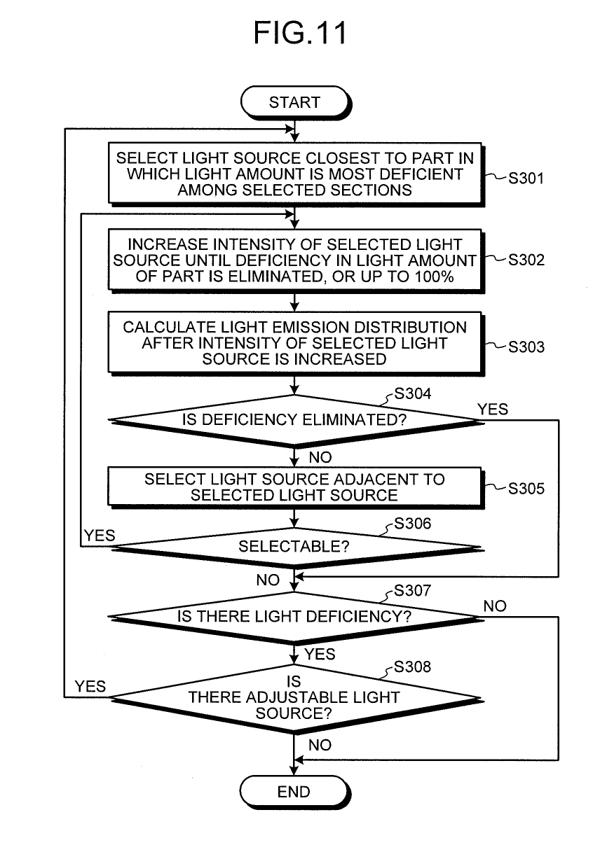

FIG. 11 is a flowchart that depicts a process procedure of the increment adjustment processing depicted in FIG. 9. As depicted in FIG. 11, the brightness comparing unit 244 finds a part in which the light amount is most deficient among sections that are selected as an adjustment target, and the adjustment-subject selecting unit 245 selects one of the light sources 11 closest to the found part as an adjustment subject (Step S301).

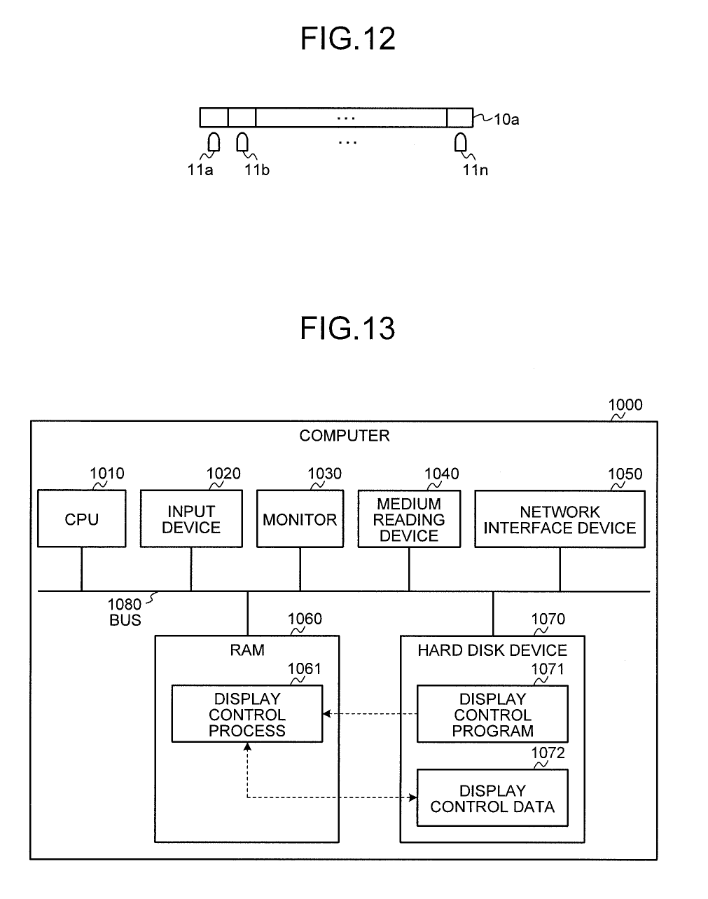

The light source 11 closest to the part most deficient in the light amount can be easily selected, by having split the section selected as the adjustment target into sections as many as the light sources 11, as depicted in FIG. 12.

The adjustment-amount determining unit 246 increases the light emission intensity of the light source 11 selected as the adjustment subject until the deficiency in the light amount of the part is eliminated, or up to 100% (Step S302). Subsequently, the light-emission distribution calculating unit 243 calculates a light emission distribution after the light emission intensity of the light source 11 selected as the adjustment subject is increased (Step S303).

The brightness comparing unit 244 then confirms whether the light-amount deficiency in the part is eliminated, as a result, if it is not eliminated (No at Step S304), the adjustment-subject selecting unit 245 selects as a new adjustment subject the light source 11 adjacent to the light source 11 selected as the adjustment subject (Step S305).

Here, light sources A to E are arranged as follows:

A B C D E;

when the light source C is selected at first as the adjustment subject, the other light sources are to be selected in the following order:

B→D→A→E, or

D→B→E→A.

If the adjacent light source 11 is selected as a new adjustment subject (Yes at Step S306), the process procedure is restarted from Step S302.

By contrast, if none of the light sources 11 is selectable as new adjustment subject (No at Step S306), otherwise if the light-amount deficiency of the part is eliminated at Step S304 (Yes at Step S304); the brightness comparing unit 244 finds another part in which the light amount is most deficient among the sections selected as the adjustment target (Step S307).

When an applicable part is found (Yes at Step S307), and if any of the light sources 11 has a margin for adjusting the light emission intensity (Yes at Step S308), the processing is restarted from Step S301. By contrast, if no part is deficient in the light amount (No at Step S307), or if none of the light sources 11 has adjustable margin of the light emission intensity (No at Step S308), the increment adjustment processing is terminated.

To avoid producing irregularities in the brightness, it can be configured to adjust a difference in increments of the light emission intensities of the adjacent light sources 11 so as to be equal to or less than a predetermined amount.

The configuration of the display apparatus 1 according to the embodiment depicted in FIG. 1 can be variously modified within a scope not departing from the outline. For example, the function of the display control apparatus 20 of the display apparatus 1 can be installed as software and executed by a computer, accordingly, a function equivalent to the display control apparatus 20 can be implemented. An example of a computer that installs thereon the function of the display control apparatus 20 as software and executes a display control program 1071 is described below.

FIG. 13 is a functional block diagram that depicts a computer 1000 that executes the display control program 1071. The computer 1000 includes a central processing unit (CPU) 1010 that executes various calculation processing; an input device 1020 that receives input of data from a user; a monitor 1030 that includes the light control unit 10; a medium reading device 1040 that reads a program and others from a recording medium; a network interface device 1050 that gives and receives data to and from other computers via a network; a random access memory (RAM) 1060 that temporarily stores various information; and a hard disk device 1070; and the included units are connected with a bus 1080.

The hard disk device 1070 stores the display control program 1071 that has a function similar to that of the display control apparatus 20 depicted in FIG. 1, and display control data 1072 corresponding to various data stored in the nonvolatile memory 30 depicted in FIG. 1. The display control data 1072 can be appropriately distributed, and stored by another computer that is connected via a network.

The CPU 1010 then reads the display control program 1071 from the hard disk device 1070, develops it on the RAM 1060, so that the display control program 1071 functions as a display control process 1061. The display control process 1061 then develops information read from the display control data 1072 in a region on the RAM 1060 allocated to itself, and executes various data processing based on the developed data.

The display control program 1071 described above does not need to be stored in the hard disk device 1070, and it can be configured such that the computer 1000 reads the program stored in a recording medium, such as a compact disk read only memory (CD-ROM) and executes it. Moreover, it can be configured such that the program is stored in another computer (or a server) that is connected to the computer 1000 via a public line, the Internet, a local area network (LAN), a wide area network (WAN), and/or the like, and the computer 1000 reads the program from those, and executes it.

As described above, according to the embodiment, it is configured to determine the light emission intensity of each light source by comparing an image of a display object with a light emission distribution composited from light emission patterns of respective light sources; accordingly, even when the light sources are arranged such that the light emission patterns are superimposed with one another, the contrast can be improved by dynamically decreasing a supply amount of light onto a black part on the image.

Although the embodiment describes above a case where the light sources are arranged in a line under an image, arrangement of the light sources is not limited to this pattern. For example, the display control method according to the embodiment can be easily applied even to a case of irradiating from an upside and a downside. Specifically, the processing of selecting a section for an adjustment target in ascending order of distance in one irradiation direction is changed to processing of selecting a section in ascending order of distance in respective irradiation directions. For example, when the light sources 11 are arranged in a line on each of the upper part and the lower part of the light control unit 10, sections can be selected from the upper side direction and the lower side direction toward the center.

In such a case, the correction pattern data 31 depicted in FIG. 3 can be preferably corrected such that correction amounts when an excessive portion is in “upper right” and in “upper left” are equal to correction amounts when an exceeding portion is in “lower right” and in “lower left”, respectively. Moreover, at Step 5304, it can be configured to select the opposite light source 11 in addition to the adjacent light source 11.

According to an aspect of the display control apparatus, the display apparatus, and the display control program disclosed in the present application, high-contrast image display can be implemented at a low cost.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A display control apparatus for controlling a light control unit that changes one of light transmittance and reflectance with respect to each pixel, and a plurality of light sources that emit light to the light control unit, the display control apparatus comprising:
a light-emission distribution calculating unit that calculates a light emission distribution when the light sources are turned on with respective set light-emission intensities based on light-emission pattern data of the respective light sources that are preliminarily stored;
a brightness comparing unit that compares a brightness in the light emission distribution calculated by the light-emission distribution calculating unit with a brightness of an image of a display object; and
an adjustment-amount determining unit that determines an adjustment amount of a light emission intensity of each light source based on a comparison result by the brightness comparing unit.

2. The display control apparatus according to claim 1, wherein
each of the light sources is a light source that emits light so as to diffuse in an irradiation area expanding as getting farther from each light source, and
the brightness comparing unit compares the light emission distribution and the image starting from a part close to arranged positions of the light sources.

3. The display control apparatus according to claim 1, wherein
the light sources are arranged along at least one side of the light control unit, and
the brightness comparing unit compares the light emission distribution and the image starting from a part close to the side on which the light sources are arranged.

4. The display control apparatus according to claim 1, further comprising a light-source intensity initial-setting unit that sets an initial value of a light emission intensity of each light source with respect to an image that is to be displayed next, based on an adjustment result of a light emission intensity of each light source with respect to an image that is previously displayed.

5. The display control apparatus according to claim 1, further comprising a reduced-image creating unit that creates a reduced image that is reduced from an image of a display object, wherein the brightness comparing unit compares the light emission distribution with the reduced image instead of the image of the display object.

6. The display control apparatus according to claim 5, further comprising a correction unit that performs correction for decreasing a brightness value of some of pixels included in the reduced image, wherein the brightness comparing unit compares the light emission distribution with corrected reduced image instead of the image of the display object.

7. A display apparatus comprising:
a light control unit that changes one of a light transmittance and a reflectance with respect to each pixel;
a plurality of light sources that emit light to the light control unit;
a light-emission distribution calculating unit that calculates a light emission distribution when the light sources are turned on with respective set light emission intensities based on light-emission pattern data of the respective light sources that are preliminarily stored;
a brightness comparing unit that compares a brightness in the light emission distribution calculated by the light-emission distribution calculating unit and a brightness of an image of a display object; and
an adjustment-amount determining unit that determines an adjustment amount of a light emission intensity of each light source based on a comparison result by the brightness comparing unit.

8. The display apparatus according to claim 7, wherein
each of the light sources is a light source that irradiates light so as to diffuse in an irradiation area expanding as getting farther from each light source, and
the brightness comparing unit compares the light emission distribution and the image starting from a part close to an arranged position of the light sources.

9. The display apparatus according to claim 7, wherein
the light sources are arranged along at least one side of the light control unit, and
the brightness comparing unit compares the light emission distribution and the image starting from a part close to the side on which the light sources are arranged.

10. The display apparatus according to claim 7, further comprising a light-source intensity initial-setting unit that sets an initial value of a light emission intensity of each light source with respect to an image that is to be displayed next, based on an adjustment result of a light emission intensity of each light source with respect to an image that is previously displayed.

11. The display apparatus according to claim 7, further comprising a reduced-image creating unit that creates a reduced image that is reduced from an image of a display object, wherein the brightness comparing unit compares the light emission distribution with the reduced image instead of the image of the display object.

12. The display apparatus according to claim 11, further comprising a correction unit that performs correction for decreasing a brightness value of some of pixels included in the reduced image, wherein the brightness comparing unit compares the light emission distribution with corrected reduced image instead of the image of the display object.

13. A computer-readable, non-transitory medium storing a display control program for controlling a light control unit that changes one of light transmittance and reflectance with respect to each pixel, and a plurality of light sources that irradiates light to the light control unit, the display control program causing a computer to execute a process, the process comprising:
calculating a light emission distribution when the light sources are tuned on with respective set light emission intensities based on light-emission pattern data of the respective light sources that are preliminarily stored;
comparing a brightness in the calculated light emission distribution with a brightness of an image of a display object; and
determining an adjustment amount of a light emission intensity of each light source based on a comparison result at the comparing.

14. The computer-readable, non-transitory medium according to claim 13, wherein
each of the light sources is a light source that emits light so as to diffuse in an irradiation area expanding as getting farther from each light source, and
the comparing includes comparing the light emission distribution and the image starting from a part close to arranged positions of the light sources.

15. The computer-readable, non-transitory medium according to claim 13, wherein
the light sources are arranged along at least one side of the light control unit, and
the comparing includes comparing the light emission distribution and the image starting from a part close to the side on which the light sources are arranged.

16. The computer-readable, non-transitory medium according to claim 13, wherein the process further comprises setting an initial value of a light emission intensity of each light source with respect to an image that is to be displayed next based on an adjustment result of a light emission intensity of each light source with respect to an image that is previously displayed.

17. The computer-readable, non-transitory medium according to claim 13, wherein
the process further comprises creating a reduced image that is reduced from an image of a display object, and
the comparing includes comparing the light emission distribution with the reduced image instead of the image of the display object.

18. The computer-readable, non-transitory medium according to claim 17, wherein
the process further comprises performing correction for decreasing a brightness value of some of pixels included in the reduced image, and
the comparing includes comparing the light emission distribution with corrected reduced image instead of the image of the display object.
